(19) United States
(12) Patent Application Publication
(10) Pub. No.: US 2020/0378494 A1
(43) Pub. Date: Dec. 3, 2020

(54) VEHICLE DRIVE-FORCE TRANSMITTING APPARATUS

(71) Applicant: Toyota Jidosha Kabushiki Kaisha, Toyota-shi (JP)

(72) Inventors: Hiromitsu NITANI, Okazaki-shi (JP); Yusuke OHGATA, Miyoshi-shi (JP); Yoshinobu SOGA, Toyota-shi (JP); Shinji OITA, Toyota-shi (JP)

(73) Assignee: Toyota Jidosha Kabushiki Kaisha, Toyota-shi (JP)

(21) Appl. No.: 16/884,450

(22) Filed: May 27, 2020

(30) Foreign Application Priority Data
May 28, 2019 (JP) 2019-099456

(51) Int. Cl. F16H 61/14; F16H 61/688; F16H 61/664

(52) U.S. Cl. CPC F16H 61/143; F16H 2061/6608; F16H 61/664; F16H 61/688

(57) ABSTRACT

A vehicle drive-force transmitting apparatus including: a mode switching clutch; a torque converter; a lock-up clutch included in the torque converter; a switching solenoid valve configured to output a switching pressure for switching an operating mode of the mode switching clutch between a one-way mode and a lock mode; and a lock-up clutch control valve configured to switch an operating state of the lock-up clutch between an engaged state and a released state. The mode switching clutch is to be placed in the lock mode when the switching pressure is supplied from the switching solenoid valve to the mode switching clutch. The lock-up clutch control valve is configured to receive the switching pressure supplied from the switching solenoid valve, and to switch the operating state of the lock-up clutch to the released state when the switching pressure is supplied to the lock-up clutch control valve.

This application claims priority from Japanese Patent Application No. 2019-099456 filed on May 28, 2019, the disclosure of which is herein incorporated by reference in its entirety.

### FIELD OF THE INVENTION

The present invention relates to a drive-force transmitting apparatus for a vehicle, wherein the drive-force transmitting apparatus defines first and second drive-force transmitting paths that are provided in parallel to each other between an engine and drive wheels of the vehicle.

### BACKGROUND OF THE INVENTION

There is known a drive-force transmitting apparatus that is to be installed in a vehicle including an engine and drive wheels, wherein the drive-force transmitting apparatus includes first and second clutches, a gear mechanism, a dog clutch and a continuously variable transmission, and defines first and second drive-force transmitting paths that are provided in parallel to each other between the engine and the drive wheels, and wherein the first drive-force transmitting path is provided with the first clutch, the gear mechanism and the dog clutch, while the second drive-force transmitting path is provided with the continuously variable transmission and the second clutch. Such a drive-force transmitting apparatus is disclosed in JP-5765485-B2.

### SUMMARY OF THE INVENTION

By the way, in the drive-force transmitting apparatus disclosed in JP-5765485-B2, when a manual shift-down operation is executed to switch a drive-force transmitting (along which a drive force is to be transmitted during running of the vehicle) from the second drive-force transmitting path to the first drive-force transmitting path, since the dog clutch is in its engaged state, a clutch-to-clutch control is executed to release the second clutch and engage the first clutch in a shift-down transition. For the purpose of reducing the cost, the dog clutch may be replaced by a mode switching clutch, which is to be placed in a selected one of a plurality of operating modes including at least a one-way mode and a lock mode, such that the mode switching clutch is configured to transmit the drive force during a driving state of the vehicle and to cut off transmission of the drive force during a driven state of the vehicle when the mode switching clutch is placed in the one-way mode, and such that the mode switching clutch is configured to transmit the drive force during the driving state of the vehicle and during the driven state of the vehicle when the mode switching clutch is placed in the lock mode. In this arrangement employing the mode switching clutch, when the manual shift-down operation is executed to switch the drive-force transmitting path from the second drive-force transmitting path to the first drive-force transmitting path, an operating mode of the mode switching clutch is switched from the one-way mode to the lock mode, and there is a risk of generation of a switching shock if the switching to the lock mode is made with a difference of rotational speed between rotary elements disposed on respective front-side and rear-side of the mode switching clutch.

The present invention was made in view of the background art described above. It is therefore an object of the present invention to provide an apparatus to be installed in a vehicle that includes an engine and drive wheels, wherein the apparatus includes a first clutch, a second clutch and a mode switching clutch, and defines first and second drive-force transmitting paths that are provided in parallel to each other between the engine and the drive wheels, such that the first drive-force transmitting path is provided with the first clutch and the mode switching clutch while the second drive-force transmitting path is provided with the second clutch, and wherein the apparatus is capable of reducing a switching shock generated in a switching transition from the one-way mode to the lock mode in the mode switching clutch when a drive-force transmitting is switched from the second drive-force transmitting path to the first drive-force transmitting path during running of the vehicle.

The object indicated above is achieved according to the following aspects of the present invention.

According to a first aspect of the invention, there is provided a drive-force transmitting apparatus to be installed in a vehicle that includes an engine and drive wheels. The drive-force transmitting apparatus comprises a first clutch, a second clutch, a mode switching clutch and a torque converter that includes a lock-up clutch. The drive-force transmitting apparatus defines first and second drive-force transmitting paths that are provided in parallel to each other between the engine and the drive wheels. The first drive-force transmitting path is provided with the first clutch and the mode switching clutch, such that the first clutch is disposed between the mode switching clutch and the engine in the first drive-force transmitting path. The second drive-force transmitting path is provided with the second clutch. The torque converter is provided between the engine and the first and second drive-force transmitting paths. An operating mode of the mode switching clutch is to be switched between at least a one-way mode and a lock mode, such that the mode switching clutch is configured to transmit a drive force during a driving state of the vehicle and to cut off transmission of the drive force during a driven state of the vehicle when the mode switching clutch is placed in the one-way mode, and such that the mode switching clutch is configured to transmit the drive force during the driving state of the vehicle and during the driven state of the vehicle when the mode switching clutch is placed in the lock mode. The drive-force transmitting apparatus further comprises: a switching solenoid valve configured to output a switching pressure by which the operating mode of the mode switching clutch is to be switched between at least the one-way mode and the lock mode; and a lock-up clutch control valve configured to switch an operating state of the lock-up clutch between an engaged state and a released state. The mode switching clutch is placed in the lock mode when the switching pressure is supplied from the switching solenoid valve to the mode switching clutch. The lock-up clutch control valve is configured to receive the switching pressure supplied from the switching solenoid valve, and to switch the operating state of the lock-up clutch to the released state when the switching pressure is supplied from the switching solenoid valve to the lock-up clutch control valve. For example, each of the mode switching clutch and the lock-up clutch control valve is connected to the switching solenoid valve through a fluid passage through which the switching pressure outputted by the switching solenoid valve is to be supplied to the mode switching clutch and the lock-up clutch control valve. Further, for example, the lock-up clutch is to be placed in the engaged state when a lock-up pressure is supplied through the lock-up clutch control valve to a fluid chamber defined in the torque converter, and is to be placed in the released state when the lock-up pressure is discharged through the lock-up clutch control valve from the fluid chamber, wherein the lock-up clutch control valve is to be switched between a first communicating state and a second communicating state, such that the lock-up clutch control valve allows supply of the lock-up pressure through the lock-up clutch control valve to the fluid chamber, when the lock-up clutch control valve is placed in the first communicating state, and such that the lock-up clutch control valve allows discharge of the lock-up pressure through the lock-up clutch control valve from the fluid chamber, when the lock-up clutch control valve is placed in the second communicating state, and wherein, when the switching pressure is supplied from the switching solenoid valve to the lock-up clutch control valve, the lock-up clutch control valve is placed in the second communicating state, whereby the lock-up pressure is discharged through the lock-up clutch control valve from the fluid chamber so as to place the lock-up clutch in the released state.

According to a second aspect of the invention, the drive-force transmitting apparatus according to the first aspect of the invention further comprises a gear mechanism and a continuously variable transmission, wherein the gear mechanism is provided in the first drive-force transmitting path, and is disposed between the mode switching clutch and the engine in the first drive-force transmitting path, and wherein the continuously variable transmission is provided in the second drive-force transmitting path.

According to a third aspect of the invention, the drive-force transmitting apparatus according to the second aspect of the invention further comprises a forward/reverse switching device which is provided in the first drive-force transmitting path and which is disposed between the gear mechanism and the engine in the first drive-force transmitting path, wherein the forward/reverse switching device is constituted by a planetary gear device, and wherein the first clutch is configured to connect two rotary elements of the planetary gear device to each other and to disconnect the two rotary elements from each other.

In the drive-force transmitting apparatus according to the first aspect of the invention, when the second drive-force transmitting path is to be switched to the first drive-force transmitting path, the operating mode of the mode switching clutch is switched from the one-way mode to the lock mode with the switching pressure being supplied from the switching solenoid valve to the mode switching clutch. The lock-up clutch control valve is configured, when the switching pressure is supplied from the switching solenoid valve to the lock-up clutch control valve, to switch the operating state of the lock-up clutch to the released state. Therefore, when the switching pressure is outputted from the switching solenoid valve, the lock-up clutch is placed into the released state. Thus, in the switching transition from the one-way mode to the lock mode in the mode switching clutch, the lock-up clutch is placed in the released state whereby a connection between the engine and the torque converter (i.e., between the engine and the first and second drive-force transmitting paths) through the lock-up clutch is cut off. As a result of the placement of the lock-up clutch in the released state, an inertia acting on an upstream side of the mode switching clutch is reduced by a magnitude corresponding to an inertia of the engine, whereby the switching shock generated in the switching transition from the one-way mode to the lock mode in the mode switching clutch can be made smaller than in a case in which the lock-up clutch is placed in the engaged state.

In the drive-force transmitting apparatus according to the second aspect of the invention, when the first drive-force transmitting path provided with the gear mechanism is established, a gear ratio of the drive-force transmitting apparatus becomes dependent of a gear ratio of the gear mechanism. Further, when the second drive-force transmitting path provided with the continuously variable transmission is established, the gear ratio of the drive-force transmitting apparatus can be continuously changed by operation of the continuously variable transmission.

In the drive-force transmitting apparatus according to the third aspect of the invention, the first clutch is provided to connect and disconnect the two rotary elements included in the planetary gear device that constitutes the forward/reverse switching device, to and from each other, such that all rotary elements of the planetary gear device are to be rotated integrally with one another with the first clutch being engaged. Therefore, the drive force of the engine is transmitted toward the gear mechanism through the forward/reverse switching device, so that it is possible to cause the vehicle to run in a forward direction with the drive force being transmitted to the drive wheels along the first drive-force transmitting path.

### BRIEF DESCRIPTION OF THE DRAWINGS

FIG. 1 is a schematic view showing a construction of a vehicle to which the present invention is applied;

FIG. 2 is a view showing a mode switching clutch shown in FIG. 1, in a state in which the mode switching clutch is placed in its one-way mode;

FIG. 3 is a view showing the mode switching clutch shown in FIG. 1, in a state in which the mode switching clutch is placed in its lock mode;

FIG. 4 is a table indicating an operating state of each of engagement devices for each of operating positions which is selected by operation of a shift lever that is provided in the vehicle;

FIG. 5 is a time chart showing a control status in a conventional construction when a position M2 is switched to a position M1 by a shift-down operation made by an operator of the vehicle during running of the vehicle with the position M2 being established;

FIG. 6 is a circuit diagram showing a part of a hydraulic control unit for controlling a drive-force transmitting apparatus that is to be installed in the vehicle, wherein the part of the hydraulic control unit is configured to control a working fluid supplied to each of a lock-up clutch and a hydraulic actuator of the mode switching clutch; and

FIG. 7 is a time chart showing a control status when the position M2 is switched to the position M1 by a shift-down operation made by the operator during running of the vehicle with the position M2 being established.

### DETAILED DESCRIPTION OF PREFERRED EMBODIMENT

Hereinafter, a preferred embodiment of the invention will be described in detail with reference to the accompanying drawings. The figures of the drawings are simplified or deformed as needed, and each portion is not necessarily precisely depicted in terms of dimension ratio, shape, etc.

### Embodiment

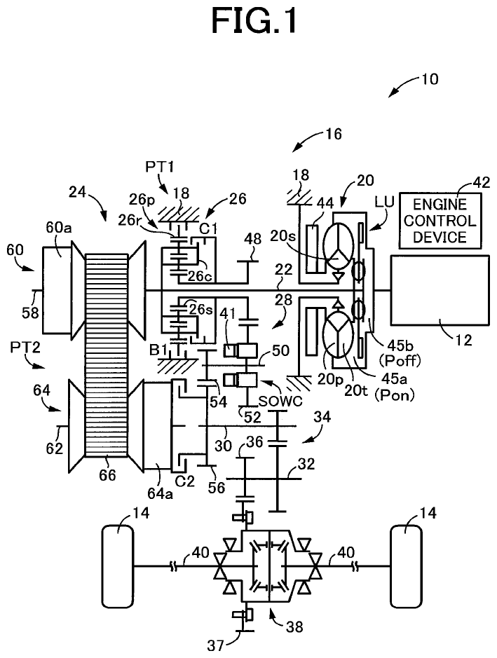

FIG. 1 is a schematic view showing a construction of a vehicle 10 to which the present invention is applied. As shown in FIG. 1, the vehicle 10 is provided with an engine 12 functioning as a drive force source configured to generate a drive force, drive wheels 14 and a vehicle drive-force transmitting apparatus 16 that is configured to transmit the drive force of the engine 12 to the drive wheels 14.

The drive-force transmitting apparatus 16 is disposed between the engine 12 and the drive wheels 14. The drive-force transmitting apparatus 16 includes a non-rotary member in the form of a casing 18, a fluid-operated type drive-force transmitting device in the form of a known torque converter 20 that is connected to the engine 12, an input shaft 22 connected to an output side of the torque converter 20, a belt-type continuously variable transmission 24 connected to the input shaft 22, a forward/reverse switching device 26 connected to the input shaft 22, a gear mechanism 28 which is provided in parallel with the continuously variable transmission 24 and which is connected to the input shaft 22 via the forward/reverse switching device 26, an output shaft 30 serving as an output rotary member that is common to the continuously variable transmission 24 and the gear mechanism 28, a drive-force transmitting shaft 32, a reduction gear device 34 consisting of a pair of mutually meshing gears each of which is connected to a corresponding one of the output shaft 30 and the drive-force transmitting shaft 32 so as to unrotatable relative to the corresponding one of the shafts 30, 32, a gear 36 connected to the drive-force transmitting shaft 32 so as to be unrotatable relative to the drive-force transmitting shaft 32, a differential gear device 38 having a differential ring gear 37 meshing with the gear 36, and right and left axles 40 that are connected to the differential gear device 38. The torque converter 20, input shaft 22, continuously variable transmission 24, forward/reverse switching device 26, gear mechanism 28, output shaft 30, drive-force transmitting shaft 32, reduction gear device 34, gear 36 and differential gear device 38 are disposed within the casing 18.

In the drive-force transmitting apparatus 16 constructed as described above, the drive force generated by the engine 12 is transmitted to the right and left drive wheels 14, via the torque converter 20, forward/reverse switching device 26, gear mechanism 28, reduction gear device 34, differential gear device 38, axles 40 and other elements, or alternatively, via the torque converter 20, continuously variable transmission 24, reduction gear device 34, differential gear device 38, axles 40 and other elements. It is noted that the above-described drive force is synonymous with a drive torque or a drive power unless otherwise distinguished from them.

The engine 12 is provided with an engine control device 42 including an electronic throttle device, a fuel injection device, an ignition device and other devices that are required for controlling an output of the engine 12. In the engine 12, the engine control device 42 is controlled, by an electronic control apparatus (not shown), based on an operation amount of an accelerator pedal that corresponds to a required drive force of the vehicle 10 required by an operator of the vehicle 10, whereby an engine torque Te as an output torque of the engine 12 is controlled.

The torque converter 20 is disposed between the engine 12 and the input shaft 22, namely, between the engine 12 and the first and second drive-force transmitting paths PT1, PT2, and is a fluid-operated type drive-force transmitting device configured to covert the engine torque Te outputted from the engine 12, though a fluid. The torque converter 20 includes a pump impeller 20p connected to the engine 12, a turbine impeller 20t is connected to the input shaft 22, and a stator impeller 20s connected to the casing 18 through a one-way clutch. The torque converter 20 is a fluid drive-force transmitting device configured to transmit the drive force of the engine 12 to the input shaft 22 through the fluid. Since the torque converter 20 is a known device, detailed description thereof will not be provided.

Further, the torque converter 20 is provided with a known lock-up clutch LU through which the pump impeller 20p and the turbine impeller 20t can be connected directly to each other. An operating state of the lock-up clutch LU, based on which the pump impeller 20p and the turbine impeller 20t (i.e., the engine 12 and the input shaft 22) are to be connected to each other or are disconnected from each other, is controlled depending on a running state of the vehicle 10. Specifically, the torque converter 20 defines therein an engaging-side fluid chamber 45a and a releasing-side fluid chamber 45b, and a pressure difference (=Pon−Poff) between a hydraulic pressure Pon of the engaging-side fluid chamber 45a and a hydraulic pressure Poff of the releasing-side fluid chamber 45b is adjusted whereby the operating state of the lock-up clutch LU is controlled. It is noted that the engaging-side fluid chamber 45a corresponds to “fluid chamber” recited in the appended claims.

The drive-force transmitting apparatus 16 defines first and second drive-force transmitting paths PT1, PT2 that are provided in parallel to each other between the engine 12 and the drive wheels 14 (more precisely, between the input and output shafts 22, 30). The first drive-force transmitting path PT1 is provided with the gear mechanism 28, while the second drive-force transmitting path PT2 is provided with the continuously variable transmission 24.

The first drive-force transmitting path PT1 is provided with: the forward/reverse switching device 26 including a first clutch C1 and a first brake B1; the gear mechanism 28; and a mode switching clutch SOWC, and is a drive-force transmitting path along which the drive force of the engine 12 is to be transmitted from the input shaft 22 to the drive wheels 14 through the gear mechanism 28. In the first drive-force transmitting path PT1, the forward/reverse switching device 26, gear mechanism 28 and mode switching clutch SOWC are arranged in this order of description in a direction away from the engine 12 toward the drive wheels 14. Therefore, the first clutch C1, which is included in the forward/reverse switching device 26, is disposed between the mode switching clutch SOWC and the engine 12.

The second drive-force transmitting path PT2 is provided with the continuously variable transmission 24 and a second clutch C2, and is a drive-force transmitting path along which the drive force of the engine 12 is to be transmitted from the input shaft 22 to the drive wheels 14 through the continuously variable transmission 24. In the second drive-force transmitting path PT2, the continuously variable transmission 24 and second clutch C2 are arranged in this order of description in a direction away from the engine 12 toward the drive wheels 14.

The forward/reverse switching device 26 is disposed is disposed between the gear mechanism 28 and the engine 12 in the first drive-force transmitting path PT1, namely, disposed on an upstream side of the gear mechanism 28 in the first drive-force transmitting path PT1. The forward/reverse switching device 26 includes a planetary gear device 26p of double-pinion type in addition to the first clutch C1 and the first brake B1. The planetary gear device 26p is a differential mechanism including three rotary elements consisting of an input element in the form of a carrier 26c, an output element in the form of a sun gear 26s and a reaction element in the form of a ring gear 26r. The carrier 26c is connected to the input shaft 22. The ring gear 26r is operatively connected to the casing 18 through the first brake B1. The sun gear 26s is disposed radially outside the input shaft 22, and is connected to a small-diameter gear 48 that is rotatable relative to the input shaft 22. The first clutch C1 is configured to connect and disconnect the carrier 26c and the sun gear 26s to each other and from each other.

Each of the first clutch C1 and first brake B1 is a known hydraulically-operated wet-type frictional engagement device that is to be frictionally engaged by operation of a hydraulic actuator. Each of the first clutch C1 and first brake B1 constitutes a part of the forward/reverse switching device 26. For example, when the first clutch C1 is engaged, the sun gear 26s, carrier 26c and ring gear 26r become rotatable integrally with one another. Therefore, with the first clutch C1 being engaged, a rotation of the input shaft 22 is transmitted to the small-diameter gear 48, without a speed of the rotation being increased or reduced, thereby enabling the vehicle 10 to run in a forward direction. With the first brake B1 being engaged, the rotation of the input shaft 22 is transmitted to the small-diameter gear 48, with a direction of the rotation being inverted, thereby enabling the vehicle 10 to run in a reverse direction.

The gear mechanism 28 is disposed is disposed between the mode switching clutch SOWC and the engine 12 in the first drive-force transmitting path PT1, namely, disposed on an upstream side of the mode switching clutch SOWC in the first drive-force transmitting path PT1. The gear mechanism 28 includes, in addition to the above-described small-diameter gear 48, a counter shaft 50 and a large-diameter gear 52 which meshes with the small-diameter gear 48 and which is mounted on the counter shaft 50, rotatably relative to the counter shaft 50. The gear mechanism 28 further includes a counter gear 54 and an output gear 56. The counter gear 54 is mounted on the counter shaft 50, unrotatably relative to the counter shaft 50, and meshes with the output gear 56 that is mounted on the output shaft 30.

The continuously variable transmission 24 includes a primary shaft 58 provided to be coaxial with the input shaft 22 and connected integrally to the input shaft 22, a primary pulley 60 connected to the primary shaft 58 and having a variable effective diameter, a secondary shaft 62 provided to be coaxial with the output shaft 30, a secondary pulley 64 connected to the secondary shaft 62 and having a variable effective diameter, and a transfer element in the form of a transmission belt 66 looped over or mounted on the pulleys 60, 64. The continuously variable transmission 24 is a known belt-type continuously variable transmission in which the drive force is transmitted owing to a friction force generated between the transmission belt 66 and each of the pulleys 60, 64, and is configured to transmit the drive force of the engine 12 toward the drive wheels 14. The effective diameter of the primary pulley 60 is changed by operation of the hydraulic actuator 60a, while the effective diameter of the secondary pulley 64 is changed by operation of the hydraulic actuator 64a.

The gear mechanism 28, which is provided in the first drive-force transmitting path PT1, provides a gear ratio EL (=input-shaft rotational speed Nin/output-shaft rotational speed Nout) that is higher than a highest gear ratio in the second drive-force transmitting path PT2 which corresponds to a highest gear ratio ymax of the continuously variable transmission 24. That is, the gear ratio EL of the gear mechanism 28, which may be interpreted also as a gear ratio in the first drive-force transmitting path PT1, is set to be a gear ratio that provides a lower speed than the highest gear ratio ymax, so that a gear ratio established in the second drive-force transmitting path PT2 provides a higher speed than the gear ratio EL established in the first drive-force transmitting path PT1. It is noted that the input-shaft rotational speed Nin is a rotational speed of the input shaft 22 and that the output-shaft rotational speed Nout is a rotational speed of the output shaft 30.

In the drive-force transmitting apparatus 16, one of the first and second drive-force transmitting paths PT1, PT2, which is selected depending on the running state of the vehicle 10, is established, and the drive force of the engine 12 is transmitted to the drive wheels 14 along the established one of the first and second drive-force transmitting paths PT1, PT2. Therefore, the drive-force transmitting apparatus 16 includes a plurality of engagement devices for selectively establishing the first and second drive-force transmitting paths PT1, PT2. The plurality of engagement devices include the above-described first clutch C1, first brake B1, second clutch C2 and mode switching clutch SOWC.

The first clutch C1, which is provided in the first drive-force transmitting path PT1, is an engagement device which is configured to selectively connect and disconnect the first drive-force transmitting path PT1, and which is configured, when the vehicle 10 is to run in the forward direction, to enable the drive force to be transmitted along the first drive-force transmitting path PT1, by being engaged. The first brake B1, which is also provided in the first drive-force transmitting path PT1, is an engagement device which is configured to selectively connect and disconnect the first drive-force transmitting path PT1, and which is configured, when the vehicle 10 is to run in the reverse direction, to enable the drive force to be transmitted along the first drive-force transmitting path PT1 by being engaged. Thus, the first drive-force transmitting path PT1 is established by engagement of either the first clutch C1 or the first brake B1.

The mode switching clutch SOWC, which is also provided in the first drive-force transmitting path PT1, is to be placed in a selected one of a one-way mode and a lock mode, such that the mode switching clutch SOWC is configured to transmit the drive force during a driving state of the vehicle 10 in the forward running and to cut off transmission of the drive force during a driven state of the vehicle 10 in the forward running when the mode switching clutch SOWC is placed in the one-way mode, and such that the mode switching clutch SOWC is configured to transmit the drive force during the driving state of the vehicle 10 and during the driven state of the vehicle 10 when the mode switching clutch SOWC is placed in the lock mode.

For example, with the first clutch C1 being placed in the engaged state and with the mode switching clutch SOWC being placed in the one-way mode, the drive force is transmittable along the first drive-force transmitting path PT1 during the driving state of the vehicle 10 during which the vehicle 10 runs in the forward direction by the drive force of the engine 12. That is, during the forward running of the vehicle 10, the drive force of the engine 12 is transmitted to the drive wheels 14 along the first drive-force transmitting path PT1. On the other hand, during the driven state of the vehicle 10, for example, during an inertia running of the vehicle 10 in the forward direction, rotation transmitted from the drive wheels 14 is blocked by the mode switching clutch SOWC even when the first clutch C1 is in the engaged state. It is noted that the driving state of the vehicle 10 is a state in which a torque applied to the input shaft 22 takes a positive value so as to act on the input shaft 22 in a direction corresponding to a direction of the running of the vehicle 10, namely, practically, a state in which the vehicle 10 is driven by the drive force of the engine 12. It is further noted that the driven state of the vehicle 10 is a state in which a torque applied to the input shaft 22 takes a negative value so as to act on the input shaft 22 in a direction opposite to the above-described direction corresponding to the direction of the running of the vehicle 10, namely, practically, a state in which the vehicle 10 is caused to run by an inertia with the input shaft 22 and the engine 12 being dragged by rotation transmitted from the drive wheels 14.

Further, in a state in which the mode switching clutch SOWC is in the lock mode with the first clutch C1 being in the engaged state, the drive force is enabled to be transmitted through the mode switching clutch SOWC during the driven state of the vehicle 10 as well as during the driving state of the vehicle 10. In this state, the drive force of the engine 12 is transmitted to the drive wheels 14 along the first drive-force transmitting path PT1, and, during the driven state of the vehicle 10 such as the inertia running, the rotation transmitted from the drive wheels 14 is transmitted to the engine 12 along the first drive-force transmitting path PT1 whereby the engine 12 is dragged to generate an engine brake. Further, in a state in which the mode switching clutch SOWC is in the lock mode with the first brake B1 being in the engaged state, the drive force of the engine 12 is transmitted to the drive wheels 14 through the mode switching clutch SOWC along the first drive-force transmitting path PT1 and acts on the drive wheels 14 so as to force the drive wheels 14 to be rotated in a direction that causes the vehicle 10 to run in the reverse direction. Thus, in this state, the vehicle 10 is enabled to run in the reverse direction with the drive force transmitted along the transmitting path PT1 to the drive wheels 14. The mode switching clutch SOWC has a construction that will be described later.

The second clutch C2, which is provided in the second drive-force transmitting path PT2, is an engagement device which is configured to selectively connect and disconnect the second drive-force transmitting path PT2, and which is configured, when the vehicle 10 is to run in the forward direction, to enable the drive force to be transmitted along the second drive-force transmitting path PT2, by being engaged. The second clutch C2 is a known hydraulically-operated wet-type frictional engagement device that is to be frictionally engaged by operation of a hydraulic actuator.

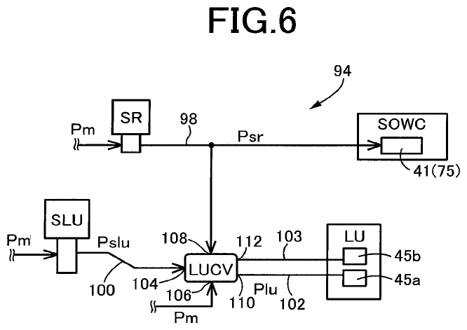

The drive-force transmitting apparatus 16 is provided with a mechanical oil pump 44 connected to the pump impeller 20p. The oil pump 44 is to be driven by the engine 12, to supply a working fluid pressure as its original pressure to a hydraulic control unit (hydraulic control circuit) 94 (see FIG. 6) that is provided in the vehicle 10, for performing a shifting control operation in the continuously variable transmission 24, generating a belt clamping force in the continuously variable transmission 24, switching the operating state of the lock-up clutch LU and switching the operating state of each of the above-described engagement devices between its engaged state and released state, or between its one-way mode and lock mode.

The construction of the mode switching clutch SOWC will be described. The mode switching clutch SOWC is provided between the large-diameter gear 52 and the counter gear 54 in an axial direction of the counter shaft 50, such that the mode switching clutch SOWC is located to be closer, than the first clutch C1 and the gear mechanism 28, to the drive wheels 14 in the first drive-force transmitting path PT1. That is, the mode switching clutch SOWC is disposed between the first clutch C1 (and the gear mechanism 28) and the output shaft 30 in the first drive-force transmitting path PT1. The mode switching clutch SOWC is switchable between the one-way mode and the lock mode by operation of a hydraulic actuator 41 that is disposed to be adjacent to the mode switching clutch SOWC in the axial direction of the counter shaft 50, so as to be placed in a selected one of the one-way mode and the lock mode.

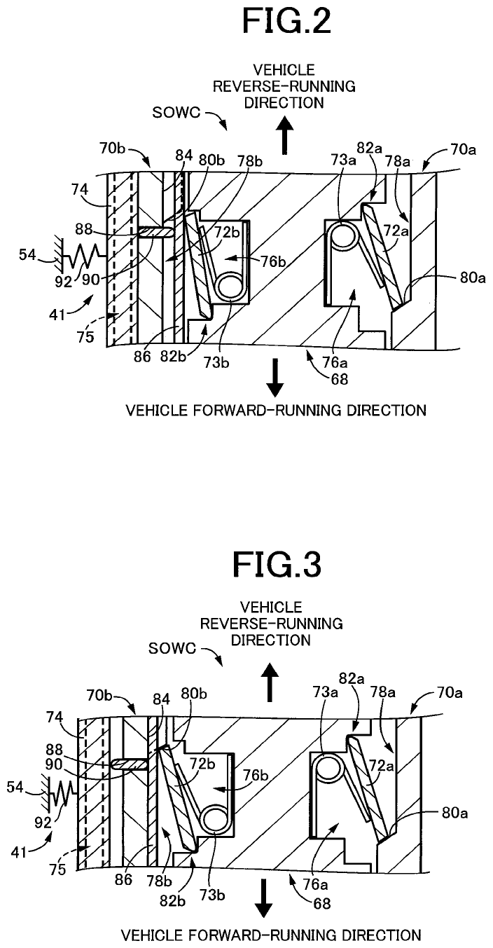

Each of FIGS. 2 and 3 is a view schematically showing the construction of the mode switching clutch SOWC, which enables switching between the one-way mode and the lock mode, wherein the view is a cross sectional view of a circumferential portion of the mode switching clutch SOWC, and the cross sectional view is a development of a cylindrical plane whose center lies on an axis of the counter shaft 50. FIG. 2 shows a state in which the mode switching clutch SOWC is placed in the one-way mode. FIG. 3 shows a state in which the mode switching clutch SOWC is placed in the lock mode. In each of FIGS. 2 and 3, a vertical direction on the drawing sheet corresponds to a circumferential direction of the mode switching clutch SOWC, an upward direction on the drawing sheet corresponds to a vehicle reverse-running direction (i.e., direction of rotation for reverse running of the vehicle 10) and a downward direction on the drawing sheet corresponds to a vehicle forward-running direction (i.e., direction of rotation for forward running of the vehicle 10). Further, in each of FIGS. 2 and 3, a horizontal direction on the drawing sheet corresponds to the axial direction of the counter shaft 50 (hereinafter, the term “axial direction” means the axial direction of the counter shaft 50 unless otherwise specified), a rightward direction on the drawing sheet corresponds to a direction toward the large-diameter gear 52 shown in FIG. 1, and a leftward direction on the drawing sheet corresponds to a direction toward the counter gear 54 shown in FIG. 1.

The mode switching clutch SOWC has generally a disk shape, and is disposed radially outside the counter shaft 50. The mode switching clutch SOWC includes an input-side rotary member 68, first and second output-side rotary members 70a, 70b that are disposed to be adjacent to the input-side rotary member 68 so as to be disposed on respective opposite sides of the input-side rotary member 68 in the axial direction, a plurality of first struts 72a and a plurality of torsion coil springs 73a that are interposed between the input-side rotary member 68 and the first output-side rotary member 70a in the axial direction, and a plurality of second struts 72b and a plurality of torsion coil springs 73b that are interposed between the input-side rotary member 68 and the second output-side rotary member 70b in the axial direction.

The input-side rotary member 68 has generally a disk shape, and is rotatable relative to the counter shaft 50 about the axis of the counter shaft 50. The input-side rotary member 68 is disposed between the first and second output-side rotary members 70a, 70b (hereinafter referred to as output-side rotary members 70 when they are not to be particularly distinguished from each other) in the axial direction. The input-side rotary member 68 is formed integrally with the large-diameter gear 52, such that teeth of the large-diameter gear 52 are disposed radially outside the input-side rotary member 68. The input-side rotary member 68 is connected to the engine 12, in a drive-force transmittable manner, through the gear mechanism 28 and the forward/reverse switching device 26, for example.

The input-side rotary member 68 has, in its axial end surface that is opposed to the first output-side rotary member 70a in the axial direction, a plurality of first receiving portions 76a in which the first struts 72a and the torsion coil springs 73a are received. The first receiving portions 76a are equi-angularly spaced apart from each other in a circumferential direction of the input-side rotary member 68. Further, the input-side rotary member 68 has, in another axial end surface thereof that is opposed to the second output-side rotary member 70b in the axial direction, a plurality of second receiving portions 76b in which the second struts 72b and the torsion coil springs 73b are received. The second receiving portions 76b are equi-angularly spaced apart from each other in the circumferential direction of the input-side rotary member 68. The first and second receiving portions 76a, 76b are substantially aligned in a radial direction of the input-side rotary member 68.

The first output-side rotary member 70a has generally a disk-shaped, and is rotatable about the axis of the counter shaft 50. The first output-side rotary member 70a is fixed to the counter shaft 50 unrotatably relative to the counter shaft 50, so as to be rotated integrally with the counter shaft 50.

The first output-side rotary member 70a has, in its surface that is opposed to the input-side rotary member 68 in the axial direction, a plurality of first recessed portions 78a each of which is recessed in a direction away from the input-side rotary member 68. The first recessed portions 78a, whose number is the same as the first receiving portions 76a, are equi-angularly spaced apart from each other in the circumferential direction. The first recessed portions 78a are substantially aligned with the first receiving portions 76a provided in the input-side rotary member 68, in a radial direction of the first output-side rotary member 70a.

Therefore, when each of the first receiving portions 76a is aligned with one of the first recessed portions 78a in the circumferential direction, namely, when a rotational position of each of the first receiving portions 76a coincides with that of one of the first recessed portions 78a, the first receiving portion 76a and the first recessed portion 78a are opposed to and adjacent with each other in the axial direction. Each of the first recessed portions 78a has a shape by which a longitudinal end portion of any one of the first struts 72a can be received in the first recessed portion 78a. Further, each of the first recessed portions 78a has, in its circumferential end, a first wall surface 80a with which the longitudinal end portion of one of the first struts 72a is to be in contact, when the input-side rotary member 68 is rotated in the above-described vehicle forward-running direction (corresponding to the downward direction on the drawing sheet of each of FIGS. 2 and 3) relative to the output-side rotary members 70, by the drive force of the engine 12.

The second output-side rotary member 70b has generally a disk-shaped, and is rotatable about the axis of the counter shaft 50. The second output-side rotary member 70b is fixed to the counter shaft 50 unrotatably relative to the counter shaft 50, so as to be rotated integrally with the counter shaft 50.

The second output-side rotary member 70b has, in its surface that is opposed to the input-side rotary member 68 in the axial direction, a plurality of second recessed portions 78b each of which is recessed in a direction away from the input-side rotary member 68. The second recessed portions 78b, whose number is the same as the second receiving portions 76b, are equi-angularly spaced apart from each other in the circumferential direction. The second recessed portions 78b are substantially aligned with the second receiving portions 76b provided in the input-side rotary member 68, in a radial direction of the second output-side rotary member 70b.

Therefore, when each of the second receiving portions 76b is aligned with one of the second recessed portions 78b in the circumferential direction, namely, when a rotational position of each of the second receiving portions 76b coincides with that of one of the second recessed portions 78b, the second receiving portion 76b and the second recessed portion 78b are opposed to and adjacent with each other in the axial direction. Each of the second recessed portions 78b has a shape by which a longitudinal end portion of any one of the second struts 72b can be received in the second recessed portion 78b. Further, each of the second recessed portions 78b has, in its circumferential end, a second wall surface 80b with which the longitudinal end portion of one of the second struts 72b is to be in contact, when the input-side rotary member 68 is rotated in the above-described vehicle reverse-running direction (corresponding to the upward direction on the drawing sheet of each of FIGS. 2 and 3) relative to the output-side rotary members 70, by the drive force of the engine 12 with the mode switching clutch SOWC being placed in the lock mode, and when the vehicle 10 is in an inertia running state during the forward running with the mode switching clutch SOWC being placed in the lock mode.

Each of the first struts 72a is constituted by a plate-like member having a predetermined thickness, and is elongated in the circumferential direction (corresponding to the vertical direction on the drawing sheet of FIGS. 2 and 3), as shown in the cross sectional views of FIGS. 2 and 3. Further, each of the first struts 72a has a predetermined dimension as measured in a direction perpendicular to the drawing sheet of FIGS. 2 and 3.

The longitudinal end portion of each of the first struts 72a is constantly forced or biased, by a corresponding one of the torsion coil springs 73a, toward the first output-side rotary member 70a. Further, each of the first struts 72a is in contact at another longitudinal end portion thereof with a first stepped portion 82a provided in a corresponding one of the first receiving portions 76a, such that the first strut 72a is pivotable about the other longitudinal end portion thereof that is in contact with the first stepped portion 82a. Each of the torsion coil springs 73a is interposed between a corresponding one of the first struts 72a and the input-side rotary member 68, and constantly forces or biases the longitudinal end portion of the corresponding one of the first struts 72a toward the first output-side rotary member 70a.

Owing to the above-described construction, in a state in which the mode switching clutch SOWC is placed in either the one-way mode or the lock mode, when the input-side rotary member 68 receives the drive force which is transmitted from the engine 12 and which acts in the vehicle forward-running direction, each of the first struts 72a is in contact at the longitudinal end portion with the first wall surface 80a of the first output-side rotary member 70a and is in contact at the other longitudinal end portion with the first stepped portion 82a of the input-side rotary member 68, so that the input-side rotary member 68 and the first output-side rotary member 70a are inhibited from being rotated relative to each other whereby the drive force acting in the vehicle forward-running direction is transmitted to the drive wheels 14 through the mode switching clutch SOWC. The above-described first struts 72a, torsion coil springs 73a, first receiving portions 76a and first recessed portions 78a (each defining the first wall surface 80a) cooperate to constitute a one-way clutch that is configured to transmit the drive force acting in the vehicle forward-running direction, to the drive wheels 14, and to cut off transmission of the drive force acting in the vehicle reverse-running direction.

Each of the second struts 72b is constituted by a plate-like member having a predetermined thickness, and is elongated in the circumferential direction (corresponding to the vertical direction on the drawing sheet of FIGS. 2 and 3), as shown in the cross sectional views of FIGS. 2 and 3. Further, each of the second struts 72b has a predetermined dimension as measured in a direction perpendicular to the drawing sheet of FIGS. 2 and 3.

The longitudinal end portion of each of the second struts 72b is constantly forced or biased, by a corresponding one of the torsion coil springs 73b, toward the second output-side rotary member 70b. Further, each of the second struts 72b is in contact at another longitudinal end portion thereof with a second stepped portion 82b provided in one of the second receiving portions 76b, such that the second strut 72b is pivotable about the other longitudinal end portion thereof that is in contact with the second stepped portion 82b. Each of the torsion coil springs 73b is interposed between a corresponding one of the second struts 72b and the input-side rotary member 68, and constantly forces or biases the longitudinal end portion of the corresponding one of the second struts 72b toward the second output-side rotary member 70b.

Owing to the above-described construction, in a state in which the mode switching clutch SOWC is placed in the lock mode, when the input-side rotary member 68 receives the drive force which is transmitted from the engine 12 and which acts in the vehicle reverse-running direction, each of the second struts 72b is in contact at the longitudinal end portion with the second wall surface 80b of the second output-side rotary member 70b and is in contact at the other longitudinal end portion with the second stepped portion 82b of the input-side rotary member 68, so that the input-side rotary member 68 and the second output-side rotary member 70b are inhibited from being rotated relative to each other whereby the drive force acting in the vehicle reverse-running direction is transmitted to the drive wheels 14 through the mode switching clutch SOWC. Further, in the state in which the mode switching clutch SOWC is placed in the lock mode, when the inertia running is made during running of the vehicle 10 in the forward direction, too, each of the second struts 72b is in contact at the longitudinal end portion with the second wall surface 80b of the second output-side rotary member 70b and is in contact at the other longitudinal end portion with the second stepped portion 82b of the input-side rotary member 68, so that the input-side rotary member 68 and the second output-side rotary member 70b are inhibited from being rotated relative to each other whereby the rotation transmitted from the drive wheels 14 is transmitted toward the engine 12 through the mode switching clutch SOWC. The above-described second struts 72b, torsion coil springs 73b, second receiving portions 76b and second recessed portions 78b (each defining the second wall surface 80b) cooperate to constitute a one-way clutch that is configured to transmit the drive force acting in the vehicle reverse-running direction, toward the drive wheels 14, and to cut off transmission of the drive force acting in the vehicle forward-running direction, toward the drive wheels 14.

Further, the second output-side rotary member 70b has a plurality of through-holes 88 that pass through the second output-side rotary member 70b in the axial direction. Each of the through-holes 88 is disposed in a position that overlaps with a corresponding one of the second recessed portions 78b in the axial direction of the counter shaft 50, so that each of the through-holes 88 is in communication at its end with a corresponding one of the second recessed portions 78b. A cylindrical-shaped pin 90 is received in each of the through-holes 88, and is slidable in the through-hole 88. The pin 90 is in contact at one of its axially opposite ends with a pressing plate 74 that constitutes a part of the hydraulic actuator 41, and is in contact at the other of its axially opposite ends with an annular ring 86 that includes a plurality of portions that are disposed in the respective second recessed portions 78b in the circumferential direction.

The ring 86 is fitted in a plurality of arcuate-shaped grooves 84, each of which is provided in the second output-side rotary member 70b and interconnects between a corresponding adjacent pair of the second recessed portions 78b that are adjacent to each other in the circumferential direction. The ring 86 is movable relative to the second output-side rotary member 70b in the axial direction.

Like the mode switching clutch SOWC, the hydraulic actuator 41 is disposed on the counter shaft 50, and is disposed in a position adjacent to the second output-side rotary member 70b in the axial direction of the counter shaft 50.

The hydraulic actuator 41 includes the above-described pressing plate 74, and defines a hydraulic chamber 75 to which a working fluid is to be supplied whereby a thrust is generated to move the pressing plate 74 toward the counter gear 54 away from the second output-side rotary member 70b in the axial direction. It is noted that the hydraulic chamber 75 is represented by broken lines in FIGS. 2 and 3 since the hydraulic chamber 75 is disposed in a position that is disposed radially inwardly of positions in which the pin 90 and other members are disposed.

The pressing plate 74 has generally a disk shape, and is disposed to be movable relative to the counter shaft 50 in the axial direction. The pressing plate 74 is constantly forced or biased by a spring 92 toward the second output-side rotary member 70b in the axial direction. Therefore, in a state in which the working fluid is not supplied to the hydraulic chamber 75 of the hydraulic actuator 41, the pressing plate 74 is moved, by biasing force of the spring 92, toward the second output-side rotary member 70b in the axial direction, whereby the pressing plate 74 is in contact with the second output-side rotary member 70b, as shown in FIG. 2. In this state, the pins 90, the ring 86 and the longitudinal end portion of each of the second struts 72b are moved toward the input-side rotary member 68 in the axial direction, as shown in FIG. 2, whereby the mode switching clutch SOWC is placed in the one-way mode.

On the other hand, in a state in which the working fluid is supplied to the above-described hydraulic chamber 75 of the hydraulic actuator 41, the pressing plate 74 is moved, against the biasing force of the spring 92, toward the counter gear 54 in the axial direction, so as to be separated from the second output-side rotary member 70b. In this state, the pins 90, the ring 86 and the longitudinal end portion of each of the second struts 72b are moved, by the biasing force of the torsion coil springs 73b, toward the counter gear 54 in the axial direction, as shown in FIG. 3, whereby the mode switching clutch SOWC is placed in the lock mode.

In the state in which the mode switching clutch SOWC is placed in the one-way mode, as shown in FIG. 2, the pressing plate 74 is in contact with the second output-side rotary member 70b by the biasing force of the spring 92. In this state, the pins 90 are forced, by the pressing plate 74, to be moved toward the input-side rotary member 68 in the axial direction, and the ring 86 is forced, by the pins 90, to be moved toward the input-side rotary member 68 in the axial direction. Consequently, the longitudinal end portion of each of the second struts 72b is forced, by the ring 86, to be moved toward the input-side rotary member 68, so as to be blocked from being in contact with the second wall surface 80b, whereby the input-side rotary member 68 and the second output-side rotary member 70b are allowed to be rotated relative to each other so that the second struts 72b do not serve as a one-way clutch. Meanwhile, the longitudinal end portion of each of the first struts 72a is biased, by the corresponding torsion coil spring 73a, toward the first output-side rotary member 70a, whereby the longitudinal end portion of each of the first struts 72a can be bought into contact with the first wall surface 80a of any one of the first recessed portions 78a so that the first struts 72a serve as a one-way clutch configured to transmit the drive force acting in the vehicle forward-running direction. That is, the first struts 72a serve as the one-way clutch that is configured to transmit the drive force during the driving state in the forward running of the vehicle 10, and to cut off transmission of the drive force during the driven state in the forward running of the vehicle 10.

In the state in which the mode switching clutch SOWC is placed in the one-way mode, as shown in FIG. 2, the longitudinal end portion of each of the first struts 72a can be brought into contact with the first wall surface 80a of the first output-side rotary member 70a. Therefore, in a state of the one-way mode of the mode switching clutch SOWC, when the vehicle 10 is placed in the driving state in which the drive force acting in the vehicle forward-running direction is transmitted from the engine 12 to the mode switching clutch SOWC, the longitudinal end portion of each of the first struts 72a is in contact with the first wall surface 80a and the other longitudinal end portion of each of the first struts 72a is in contact with the first stepped portion 82a, so that the input-side rotary member 68 is inhibited from being rotated relative to the first output-side rotary member 70a in the vehicle forward-running direction whereby the drive force of the engine 12 is transmitted to the drive wheels 14 through the mode switching clutch SOWC. On the other hand, in the state of the one-way mode of the mode switching clutch SOWC, when the vehicle 10 is placed in the driven state by inertia running during the forward running, the input-side rotary member 68 is allowed to be rotated relative to the first output-side rotary member 70a in the vehicle reverse-running direction, without the longitudinal end portion of each of the first struts 72a being in contact with the first wall surface 80a, whereby the transmission of the drive force through the mode switching clutch SOWC is blocked. Thus, in the state in which the mode switching clutch SOWC is placed in the one-way mode, the first struts 72a serve as the one-way clutch which is configured to transmit the drive force in the driving state of the vehicle 10 in which the drive force acting in the vehicle forward-running direction is transmitted from the engine 12, and which is configured to block the transmission of the drive force in the driven state of the vehicle 10 in which the vehicle 10 is in the inertia running state during the forward running. In other words, the input-side rotary member 68 is inhibited from being rotated in the vehicle forward-running direction relative to the output-side rotary members 70, and is allowed to be rotated in the vehicle reverse-running direction relative to the output-side rotary members 70, when the mode switching clutch SOWC is placed in the one-way mode.

In the state in which the mode switching clutch SOWC is placed in the lock mode, as shown in FIG. 3, the working fluid is supplied to the hydraulic chamber 75 of the hydraulic actuator 41 whereby the pressing plate 74 is moved, against the spring 92, in a direction away from the second output-side rotary member 70b, and the longitudinal end portion of each second strut 72b is moved, by biasing force of the corresponding torsion coil spring 73b, toward the corresponding second recessed portion 78b of the second output-side rotary member 70b, whereby the longitudinal end portion of each second strut 72b can be brought into contact with the second wall surface 80b of the second output-side rotary member 70b. Meanwhile, each first strut 72a can be brought into contact at the longitudinal end portion with the first wall surface 80a of the first output-side rotary member 70a, as in the state of the one-way mode shown in FIG. 2.

In the state in which the mode switching clutch SOWC is placed in the lock mode, as shown in FIG. 3, when the drive force acting in the vehicle forward-running direction is transmitted to the input-side rotary member 68, the longitudinal end portion of each first strut 72a is brought into contact with the first wall surface 80a of the first output-side rotary member 70a, and the other longitudinal end portion of each first strut 72a is brought into contact with the first stepped portion 82a of the input-side rotary member 68, whereby the input-side rotary member 68 is inhibited from being rotated relative to the first output-side rotary member 70a in the vehicle forward-running direction. In the state of the lock mode of the mode switching clutch SOWC, when the drive force acting in the vehicle reverse-running direction is transmitted to the input-side rotary member 68, the longitudinal end portion of each second strut 72b is brought into contact with the second wall surface 80b of the second output-side rotary member 70b, and the other longitudinal end portion of each second strut 72b is brought into contact with the second stepped portion 82b of the input-side rotary member 68, whereby the input-side rotary member 68 is inhibited from being rotated relative to the second output-side rotary member 70b in the vehicle reverse-running direction.

Thus, in the state of the lock mode of the mode switching clutch SOWC, the first struts 72a serve as a one-way clutch and the second struts 72b serve as a one-way clutch, so that the mode switching clutch SOWC is configured to transmit the drive force acting in the vehicle forward-running direction and the drive force acting in the vehicle reverse-running direction. In other words, the input-side rotary member 68 is inhibited from being rotated in both of opposite directions relative to the output-side rotary members 70, when the mode switching clutch SOWC is placed in the lock mode. When the vehicle 10 is to run in the reverse direction, the vehicle 10 is enabled to run in the reverse direction with the mode switching clutch SOWC being placed in the lock mode. Further, when the vehicle 10 is placed in the driven state by inertia running during the forward running, an engine brake can be generated with the mode switching clutch SOWC being placed in the lock mode by which the engine 12 is dragged by rotation transmitted from the drive wheels 14 to the engine 12 through the mode switching clutch SOWC. Thus, in the state of the lock mode of the mode switching clutch SOWC, the first struts 72a serve as a one-way clutch and the second struts 72b serve as a one-way clutch, so that the mode switching clutch SOWC is configured to transmit the drive force during the driving state and the driven state of the vehicle 10.

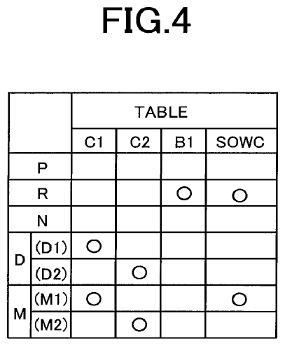

FIG. 4 is a table indicating an operating state of each of the engagement devices for each of a plurality of operating positions POSsh which is selected by operation of a manually-operated shifting device in the form of a shift lever (not shown). In FIG. 4, “C1” represents the first clutch C1, “CT” represents the second clutch C2, “B1” represents the first brake B1, and “SOWC” represents the mode switching clutch SOWC. Further, “P”, “R”, “N”, “D” and “M” represent a parking position P, a reverse position R, a neutral position N, a drive position D and a manual position M, respectively, as the plurality of operating positions POSsh, each of which is to be selected by operation of the shift lever. In the table of FIG. 4, “0” in the first clutch C1, second clutch C2 or first brake B1 indicates its engaged state, and blank in the first clutch C1, second clutch C2 or first brake B1 indicates its released state. Further, in the table of FIG. 4, “0” in the mode switching clutch SOWC indicates its lock mode, and blank in the mode switching clutch SOWC indicates its one-way mode.

For example, when the shift lever is placed in the parking position P as one of the operating positions POSsh that is a vehicle stop position or in the neutral position N as one of the operating positions POSsh that is a drive-force transmission block position, the first clutch C1, second clutch C2 and first brake B1 are placed in released positions, as indicated in FIG. 4, so that the drive-force transmitting apparatus 16 is placed in its neutral state in which the drive force is not transmitted along either the first drive-force transmitting path PT1 or the second drive-force transmitting path PT2.

When the shift lever is placed in the reverse position R as one of the operating positions POSsh that is a reverse running position, the first brake B1 is placed in the engaged state and the mode switching clutch SOWC is placed in the lock mode, as indicated in FIG. 4. With the first brake B1 being placed in the engaged state, the drive force acting in the vehicle reverse-running direction is transmitted from the engine 12 to the gear mechanism 28. In this instance, if the mode switching clutch SOWC is in the one-way mode, the drive force is blocked by the mode switching clutch SOWC so that reverse running cannot be made. Thus, with the mode switching clutch SOWC being placed in the lock mode, the drive force acting in the vehicle reverse-running direction is transmitted to the output shaft 30 through the mode switching clutch SOWC so that reverse running can be made. When the shift lever is placed in the reverse position R, the first brake B1 is placed in the engaged state and the mode switching clutch SOWC is placed in the lock mode, whereby a reverse gear position is established to transmit the drive force acting in the vehicle reverse-running direction, through the gear mechanism 28 along the first drive-force transmitting path PT1, to the drive wheels 14.

When the shift lever is placed in the drive position D as one of the operating positions POSsh that is a forward running position, the first clutch C1 is placed in the engaged state or the second clutch C2 is placed in the engaged state, as indicated in FIG. 4. In FIG. 4, “D1” and “D2” represent a drive position D1 and a drive position D2, respectively, which are operating positions virtually set in control. When the shift lever is placed in the drive position D, one of the drive position D1 and the drive position D2 is selected depending the running state of the vehicle 10, and the selected one is automatically established. The drive position D1 is established when vehicle running speed is within a relatively low speed range including zero speed (vehicle stop). The drive position D2 is established when the vehicle running speed is within a relatively high speed range including a middle speed range. For example, during running of the vehicle 10 with the shift lever being placed in the drive position D, when the running state of the vehicle 10 is changed from the low speed range to the high speed range, the drive position D1 is automatically switched to the drive position D2.

For example, when the running state of the vehicle 10 is in a speed range corresponding to the drive position D1 upon placement of the shift lever into the drive position D, the first clutch C1 is engaged and the second clutch C2 is released. In this case, a gear running mode is established whereby the drive force acting in the vehicle forward-running direction is transmitted from the engine 12 to the drive wheels 14 along the first drive-force transmitting path PT1 through the gear mechanism 28. The mode switching clutch SOWC, which is placed in the one-way mode, transmits the drive force acting in the vehicle forward-running direction, toward the drive wheels 14.

Further, when the running state of the vehicle 10 is in a speed range corresponding to the drive position D2 upon placement of the shift lever into the drive position D, the first clutch C1 is released and the second clutch C2 is engaged. In this case, a belt running mode is established whereby the drive force acting in the vehicle forward-running direction is transmitted from the engine 12 to the drive wheels 14 along the second drive-force transmitting path PT2 through the continuously variable transmission 24. Thus, when the shift lever is placed into the drive position D as one of the operating positions POSsh, the drive force of the engine 12 is transmitted to the drive wheels 14 along a selected one of the first drive-force transmitting path PT1 (gear mechanism 28) and the second drive-force transmitting path PT2 (continuously variable transmission 24), which is selected depending on the running state of the vehicle 10.

When the shift lever is placed in the manual position M as one of the operating positions POSsh, a shift-up operation or a shift-down operation can be executed by a manual operation made by the operator of the vehicle 10. That is, the manual position M is a manual shift position in which a shifting operation can be made by the manual operation made by the operator. For example, when a shift-down operation is manually made by the operator with the shift lever being placed in the manual position M, during running of the vehicle 10 with position M2 (see FIG. 4) being established, the position M2 is switched to position M1 (see FIG. 4), whereby the first and second clutches C1, C2 are engaged and released, respectively, and the mode switching clutch SOWC is placed into the lock mode, so that a forward-running gear position is established.

With the mode switching clutch SOWC being placed in the lock mode, the drive force can be transmitted through the mode switching clutch SOWC during the driven state of the vehicle 10 as well as during the driving state of the vehicle 10. During the inertia running, for example, the vehicle 10 is placed in the driven state in which the rotation is transmitted from the drive wheels 14 toward the engine 12. In the driven state, when the shift-down operation is manually executed with the shift lever being placed in the manual position M, the rotation transmitted from the drive wheels 14 is transmitted toward the engine 12 through the mode switching clutch SOWC that is placed in the lock mode, whereby the engine 12 is dragged to generate the engine brake. Thus, when the shift-down operation is executed with the shift lever being placed in the manual position M, the forward-running gear position is established so that the drive force is transmitted to the drive wheels 14 along the first drive-force transmitting path PT1 through the gear mechanism 28, and so that the rotation transmitted from the drive wheels 14 is transmitted toward the engine 12 along the first drive-force transmitting path PT1 so as to generate the engine brake during the inertia running.

When the shift-up operation is manually made by the operator with the shift lever being placed in the manual position M as one of the operating positions POSsh, during running of the vehicle 10 with the position M1 (see FIG. 4) being established, the position M1 is switched to the position M2 (see FIG. 4), whereby the second clutch C2 is engaged. In this instance, a forward-running continuously-variable shifting position is established so that the drive force is transmitted to the drive wheels 14 along the second drive-force transmitting path PT2 through the continuously variable transmission 24.

Thus, with the shift lever being placed in the manual position M, a manual shifting can be executed by a manual operation made by the operator, to select one of the forward-running gear position (i.e., the gear running mode) and the forward-running continuously-variable shifting position (i.e., the belt running mode). When the forward-running gear position is selected, the drive force can be transmitted along the first drive-force transmitting path PT1. When the forward-running continuously-variable shifting position is selected, the drive force can be transmitted along the second drive-force transmitting path PT2.

As described above, when the shift-down operation is manually made by the operator with the shift lever being placed in the manual position M, during running of the vehicle 10 with the position M2 (see FIG. 4) being established, the position M2 is switched to the position M1 (see FIG. 4), whereby the first clutch C1 is engaged and the mode switching clutch SOWC is switched from the one-way mode to the lock mode. In a switching transition from the one-way mode to the lock mode in the mode switching clutch SOWC, if there is a rotational speed difference between input rotational speed Nsoin of the input-side rotary member 68 and output rotational speed Nsoout of the output-side rotary members 70, there is a risk of generation of a shock (switching shock) that could be caused by collision between the longitudinal end portion of each of the second struts 72b and the second output-side rotary member 70b.

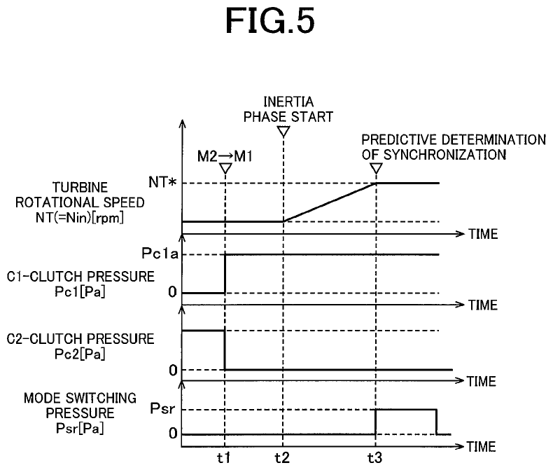

FIG. 5 is a time chart showing a control status in a conventional construction when the position M2 is switched to the position M1 by a manual operation made by the operator during running of the vehicle 10 with the position M2 being established. In FIG. 5, ordinate axes represent, as seen from top to bottom, a turbine rotational speed NT corresponding to the input-shaft rotational speed Nin of the input shaft 22, a C1-clutch pressure Pc′ that is applied to the hydraulic actuator of the first clutch C1, a C2-clutch pressure Pc2 that is applied to the hydraulic actuator of the second clutch C2, and a mode switching pressure Psr (switching pressure) for switching an operating mode of the mode switching clutch SOWC. The mode switching pressure Psr corresponds to a hydraulic pressure of the working fluid supplied to the hydraulic chamber 75 of the hydraulic actuator 41 of the mode switching clutch SOWC, and the mode switching clutch SOWC is configured, when the mode switching pressure Psr is supplied to the hydraulic chamber 75, to be placed into the lock mode. It is noted that each of the pressures shown in FIG. 5 indicates a command pressure value and that an actual pressure value follows the command pressure value with a certain delay with respect to the command pressure value.

As shown in FIG. 5, at a point t1 of time, when the position M2 is switched to the position M1 in response to a manual operation made by the operator, the C1-clutch pressure Pc1 applied to the first clutch C1 is increased to a pressure value Pcla that causes the first clutch C1 to be placed in its engaged state. Meanwhile, the C2-clutch pressure Pc2 applied to the second clutch C2 is reduced to zero. At a point t2 of time, when an inertia phase starts, the engine 12 is controlled to execute a blipping control by which the turbine rotational speed NT is increased toward a target rotational speed value NT*, which corresponds to a speed value of the turbine rotational speed NT after the switching to the position M1 from the position M2. Then, at a point t3 of time, when a rotational speed difference between an actual speed value of the turbine rotational speed NT and the target rotational speed value NT* becomes smaller than a predetermined value, it is predictively determined that the actual speed value of the turbine rotational speed NT will be synchronized with the target rotational speed value NT*, and the mode switching pressure Psr is outputted to enable the mode switching clutch SOWC to be switched from the one-way mode to the lock mode. In this instance, in the switching transition from the one-way mode to the lock mode in the mode switching clutch SOWC, if there is the above-described rotational speed difference (=Nsoout−Nsoin) between the input rotational speed Nsoin of the input-side rotary member 68 and the output rotational speed Nsoout of the output-side rotary members 70, the shock (switching shock) is generated by collision between the longitudinal end portion of each of the second struts 72b and the second output-side rotary member 70b.

On the other hand, in the present embodiment, the hydraulic control unit 94 (see FIG. 6) is constructed such that the lock-up clutch LU is placed into its lock-up-off state (i.e., released state), in the switching transition from the one-way mode to the lock mode in the mode switching clutch SOWC, for reducing the shock generated in the switching transition.

FIG. 6 is a circuit diagram showing a part of the hydraulic control unit 94 for controlling the drive-force transmitting apparatus 16, wherein the shown part of the hydraulic control unit 94 is configured to control the hydraulic pressure of the working fluid supplied to each of the lock-up clutch LU and the hydraulic actuator 41 of the mode switching clutch SOWC.

The hydraulic control unit 94 includes: a switching solenoid valve SR configured to output the mode switching pressure Psr; a lock-up control solenoid valve SLU configured to output a lock-up controlling pressure Pslu; a lock-up clutch control valve LUCV (hereinafter referred to as “control valve LUCV”) configured to switch or control the operating state of the lock-up clutch LU; a first fluid passage 98 connecting between the switching solenoid valve SR and the mode switching clutch SOWC; a second fluid passage 100 connecting between the lock-up control solenoid valve SLU and the control valve LUCV; a third fluid passage 102 connecting between the control valve LUCV and the engaging-side fluid chamber 45a of the lock-up clutch LU; and a fourth fluid passage 103 connecting between the control valve LUCV and the releasing-side fluid chamber 45b of the lock-up clutch LU.

The switching solenoid valve SR is configured to receive an original pressure in the form of a modulator pressure Pm to which a hydraulic pressure is regulated by a modulator valve (not shown), and to output the mode switching pressure Psr by which the operating mode of the mode switching clutch SOWC is to be switched. It is noted that the mode switching clutch SOWC is placed in its lock mode when the switching pressure Psr is outputted from the switching solenoid valve SR. The switching solenoid valve SR is controlled by the electronic control apparatus (not shown), and is configured, when receiving a command (command electric current) requesting the mode switching clutch SOWC to be switched to the lock mode, to output the mode switching pressure Psr whose magnitude enables the mode switching clutch SOWC to be switched to the lock mode. The mode switching pressure Psr is supplied through the first fluid passage 98 to the hydraulic actuator 41 of the mode switching clutch SOWC. The first fluid passage 98, through which the mode switching pressure Psr is to be supplied, is diverged into two branch passages, such that one of the two branch passages is connected to the mode switching clutch SOWC while the other of the two branch passages is connected to the control valve LUCV. It is noted that the first fluid passage 98 corresponds to “fluid passage” recited in the appended claims.

The lock-up control solenoid valve SLU is configured to receive the original pressure in the form of the modulator pressure Pm, and to output the lock-up controlling pressure Pslu that is to be supplied to the control valve LUCV. The lock-up control solenoid valve SLU is controlled by the electronic control apparatus, and is configured to output the lock-up controlling pressure Pslu that is dependent on the running state of the vehicle 10. The lock-up controlling pressure Pslu outputted from the lock-up control solenoid valve SLU is supplied through the second fluid passage 100 to the control valve LUCV.

The control valve LUCV has: a first input port 104 configured to receive the lock-up controlling pressure Pslu supplied from the lock-up control solenoid valve SLU; a second input port 106 configured to receive the modulator pressure Pm; a third input port 108 configured to receive the mode switching pressure Psr supplied from the switching solenoid valve SR; a first output port 110 connected to the engaging-side fluid chamber 45a of the lock-up clutch LU through the third fluid passage 102; a second output port 112 connected to the releasing-side fluid chamber 45b of the lock-up clutch LU through the fourth fluid passage 103; and a drain port (not shown).

The control valve LUCV is configured to cause the operating state of the lock-up clutch LU to be switched to a selected one of the lock-up-off state (i.e., released state) and the lock-up-on state (i.e., engaged state), which is selected depending on the mode switching pressure Psr supplied through the third input port 108. Specifically, the control valve LUCV is configured to place the lock-up clutch LU in the lock-up-off state when the mode switching pressure Psr is supplied to the control valve LUCV through the third input port 108 to the control valve LUCV.

When the mode switching pressure Psr is not supplied to the control valve LUCV through the third input port 108 to the control valve LUCV, the control valve LUCV is placed in its lock-up-on establishing state that causes the lock-up clutch LU to be placed in its lock-up-on state (i.e., engaged state) when the mode switching pressure Psr is not supplied to the control valve LUCV through the third input port 108 to the control valve LUCV. In this case, the control valve LUCV serves as a pressure regulating valve configured to regulate a hydraulic pressure to a lock-up pressure Plu, based on the lock-up controlling pressure Pslu, wherein the lock-up pressure Plu is a hydraulic pressure that is to be supplied to the engaging-side fluid chamber 45a of the lock-up clutch LU. Further, when the control valve LUCV is placed in the lock-up-on establishing state, the lock-up pressure Plu, which is a regulated output of the control valve LUCV, is supplied to the engaging-side fluid chamber 45a of the lock-up clutch LU through the first output port 110 and the third fluid passage 102. Further, with the control valve LUCV being placed in the lock-up-on establishing state, the releasing-side fluid chamber 45b of the lock-up clutch LU is brought into communication with the drain port through the fourth fluid passage 103 and the control valve LUCV. Thus, with the lock-up pressure Plu (that is the regulated output of the control valve LUCV) being supplied to the engaging-side fluid chamber 45a of the lock-up clutch LU, it is possible to control a torque capacity of the lock-up clutch LU. That is, the engaged state of the lock-up clutch LU can be finely controlled between its fully-engaged state and its slipping state. It is noted that the lock-up-on establishing state of the control valve LUCV corresponds to “first communicating state” recited in the appended claims.

On the other hand, when the mode switching pressure Psr is supplied to the control valve LUCV through the third input port 108 to the control valve LUCV, the control valve LUCV is placed in its lock-up-off establishing state that causes the lock-up clutch LU to be placed in the lock-up-off state. In this case, with the control valve LUCV being placed in the lock-up-off establishing state, the engaging-side fluid chamber 45a of the lock-up clutch LU is brought into communication with the drain port through the third fluid passage 102 and the control valve LUCV, and the releasing-side fluid chamber 45b is brought into communication with the second input port 106 through the fourth fluid passage 103 and the control valve LUCV. Thus, the modulator pressure Pm supplied through the second input port 106 to the control valve LUCV is supplied to the releasing-side fluid chamber 45b, so that the hydraulic pressure Poff of the releasing-side fluid chamber 45b becomes higher than the hydraulic pressure Pon of the engaging-side fluid chamber 45a whereby the lock-up clutch LU is released. It is noted that the lock-up-off establishing state of the control valve LUCV corresponds to “second communicating state” recited in the appended claims.

In the hydraulic control unit 94 constructed as described above, when the mode switching clutch SOWC is to be switched to the lock mode, the mode switching pressure Psr is outputted from the switching solenoid valve SR, and is supplied to the mode switching clutch SOWC and also to the control valve LUCV through the first fluid passage 98. With the mode switching pressure Psr being supplied to the control valve LUCV, the control valve LUCV being placed in the lock-up-off establishing state whereby the lock-up clutch LU is placed in the lock-up-off state in which a connection between the engine 12 and the input shaft 22 (i.e., connection between the engine 12 and the torque converter 20) through the lock-up clutch LU is cancelled, thereby resulting in reduction of an inertia acting on the upstream side (i.e., a side of the engine 12) of the mode switching clutch SOWC by a magnitude corresponding to an inertia of the engine 12. Thus, the mode switching clutch SOWC is switched to the lock mode with the lock-up clutch LU being released, so that a shock generated in the switching transition to the lock mode can be reduced as compared with an arranged in which the mode switching clutch SOWC is switched to the lock mode with the lock-up clutch LU being in the engaged state.

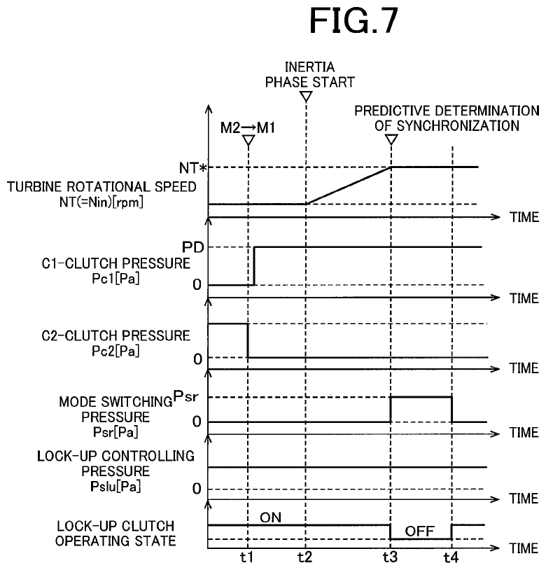

FIG. 7 is a time chart showing a control status when the position M2 is switched to the position M1, namely, a shift-down operation is made by the operator, during running of the vehicle 10 with the position M2 being established. In FIG. 7, ordinate axes represent, as seen from top to bottom, the turbine rotational speed NT corresponding to the input-shaft rotational speed Nin of the input shaft 22, the C1-clutch pressure Pc1 that is applied to the hydraulic actuator of the first clutch C1, the C2-clutch pressure Pc2 that is applied to the hydraulic actuator of the second clutch C2, the mode switching pressure Psr that is applied to the hydraulic actuator 41 of the mode switching clutch SOWC, the lock-up controlling pressure Pslu outputted from the lock-up control solenoid valve SLU, and the operating state of the lock-up clutch LU. It is noted that, in “LOCK-UP CLUTCH OPERATING STATE” in FIG. 7, “ON” indicates the lock-up-on state, i.e., the engaged state of the lock-up clutch LU, while “OFF” indicates the lock-up-off state, i.e., the released state of the lock-up clutch LU. Further, each of the pressures shown in FIG. 7 indicates a command pressure value.

As shown in FIG. 7, until a point t1 of time, the second clutch C2 is engaged so that the vehicle 10 runs in the belt running mode in which the drive force is transmitted along the second drive-force transmitting path PT2. Further, until the point t1 of time, the mode switching pressure Psr is not outputted so that the lock-up clutch LU is placed in the lock-up-on state, and the engaged state of the lock-up clutch LU is controlled based on the lock-up controlling pressure Pslu.

At the point t1 of time, when the position M2 is switched to the position M1 by the operator, the C1-clutch pressure Pc1 is increased to a pressure value PD by which the first clutch C1 is engaged, while the C2-clutch pressure Pc2 is reduced to zero. It is noted that an actual pressure value of each of the C1-clutch pressure Pc1 and the C2-clutch pressure Pc2 is changed with a certain delay with respect to the command pressure value of a corresponding one of the C1-clutch pressure Pc1 and the C2-clutch pressure Pc2, which is indicated in FIG. 7.

At a point t2 of time, when an inertia phase starts, the engine 12 is controlled to execute the blipping control by which the turbine rotational speed NT is increased toward the target rotational speed value NT*, which corresponds to a speed value of the turbine rotational speed NT after the switching to the position M1. The target rotational speed value NT* is calculated based on the output-shaft rotational speed Nout corresponding to a running speed V of the vehicle 10 and the gear ratio EL established in the first drive-force transmitting path PT1. The blipping control is performed by, for example, a feedback control that is executed to minimize a deviation in the form of the rotational speed difference ΔNT (=NT*−NT) between the target rotational speed value NT* and the turbine rotational speed NT. In this instance, since the first clutch C1 has a torque capacity, the input shaft 22 is connected through the first clutch C1 to the input-side rotary member 68 of the mode switching clutch SOWC. Therefore, in a period between the point t2 of time and a point t3 of time, when the turbine rotational speed NT is increased with execution of the blipping control, the input rotational speed Nsoin of the input-side rotary member 68 of the mode switching clutch SOWC is increased whereby the rotational speed difference of the input rotational speed Nsoin of the input-side rotary member 68 and the output rotational speed Nsoout of the output-side rotary members 70 is reduced.

At the point t3 of time, when the rotational speed difference ΔNT between the turbine rotational speed NT and the target rotational speed value NT* becomes not larger than a predetermined synchronization determination value, it is determined that the turbine rotational speed NT will be synchronized with the target rotational speed value NT*. When it is determined at the point t3 of time that turbine rotational speed NT will be synchronized with the target rotational speed value NT*, the switching solenoid valve SR is configured to output the mode switching pressure Psr whose magnitude enables the mode switching clutch SOWC to be switched to the lock mode. It is noted that the magnitude of the mode switching pressure Psr is set to a magnitude value which enables the control valve LUCV to be switched to the lock-up-off establishing state.

In this instance, the mode switching pressure Psr is supplied to the control valve LUCV through the first fluid passage 98 whereby the lock-up clutch LU is switched to the lock-up-off state, namely, the lock-up clutch LU is placed in the released state. Therefore, the mode switching clutch SOWC is switched from the one-way mode to the lock mode in a state in which the lock-up clutch LU is released, so that it is possible to reduce the shock generated in the switching transition switching transition to the lock mode in the mode switching clutch SOWC, as compared with an arrangement in which the mode switching clutch SOWC is switched to the lock mode with the lock-up clutch LU being kept engaged, even in presence of the rotational speed difference between the input-side rotary member 68 of the input rotational speed Nsoin and the output rotational speed Nsoout of the output-side rotary members 70 upon the switching to the lock mode in the mode switching clutch SOWC. That is, with the lock-up clutch LU being released, an inertia acting on the upstream side of the mode switching clutch SOWC is reduced by a magnitude corresponding to an inertia of the engine 12, so that an impact upon collision between the longitudinal end portion of each of the second struts 72b and the second output-side rotary member 70b is reduced whereby the shock generated in the switching transition the lock mode in the mode switching clutch SOWC is reduced.

Further, at a point t4 of time, when the output of the mode switching pressure Psr is cancelled, the control valve LUCV is switched to the lock-up-on establishing state whereby the lock-up clutch LU is placed back into the engaged state.

As described above, when the mode switching clutch SOWC is placed in the lock mode, the control valve LUCV is placed in the lock-up-off establishing state whereby the lock-up clutch LU is released. Therefore, owing to the reduction of the inertia acting on the upstream side of the input-side rotary member 68 of the mode switching clutch SOWC, it is possible to reduce the shock generated in the switching transition to the lock mode in the mode switching clutch SOWC.

It might be possible to place the lock-up clutch LU, practically, into the released state by controlling the lock-up controlling pressure Pslu outputted from the lock-up control solenoid valve SLU when the mode switching clutch SOWC is to be switched to the lock mode. However, this arrangement requires a complicated control that is to be executed in the switching transition to the lock mode in the mode switching clutch SOWC, for assuring a high degree of accuracy of hydraulic pressure control such as accurate synchronization of timing of outputs of the switching solenoid valve SR and the lock-up control solenoid valve SLU. On the other hand, in the present embodiment in which, when the mode switching pressure Psr is outputted from the switching solenoid valve SR so as to switch the mode switching clutch SOWC to the lock mode, the lock-up clutch LU is forcibly or necessarily switched to the lock-up-off state by the control valve LUCV that receives, as well as the mode switching clutch SOWC, the mode switching pressure Psr outputted from the switching solenoid valve SR. This arrangement does not require a high degree of accuracy of hydraulic pressure control such as accurate synchronization of timing of hydraulic pressure outputs, namely, does not require a complicated control. Thus, this arrangement does not require each of the switching solenoid valve SR and the lock-up control solenoid valve SLU to be constituted by a solenoid valve having a high accuracy, so that it is possible to restrain increase of manufacturing cost. Further, the mode switching clutch SOWC can be switched to the lock mode without a complicated control process, so that it is possible to improve a controllability in the switching transition to the lock mode in the mode switching clutch SOWC.

As described above, in the present embodiment, when the second drive-force transmitting path PT2 is to be switched to the first drive-force transmitting path PT1, the operating mode of the mode switching clutch SOWC is switched from the one-way mode to the lock mode with the switching pressure Psr being supplied from the switching solenoid valve SR to the mode switching clutch SOWC. The control valve LUCV is configured, when the switching pressure Psr is supplied from the switching solenoid valve SR to the control valve LUCV as well as to the mode switching clutch SOWC, to switch the operating state of the lock-up clutch LU to the lock-up-off state (i.e., released state). Therefore, when the switching pressure Psr is outputted from the switching solenoid valve SR, the lock-up clutch LU is placed into the lock-up-off state. Thus, in the switching transition from the one-way mode to the lock mode in the mode switching clutch SOWC, the lock-up clutch LU is placed in the lock-up-off state whereby a connection between the engine 12 and the torque converter 20 (i.e., a connection between the engine 12 and the first and second drive-force transmitting paths PT1, PT2) through the lock-up clutch LU is cut off. As a result of the placement of the lock-up clutch LU in the lock-up-off state, an inertia acting on the upstream side of the mode switching clutch SOWC is reduced by a magnitude corresponding to an inertia of the engine 12, whereby the switching shock generated in the switching transition from the one-way mode to the lock mode in the mode switching clutch SOWC can be made smaller than in a case in which the lock-up clutch LU is placed in the engaged state.

Further, in the present embodiment, when the first drive-force transmitting path PT1 provided with the gear mechanism 28 is established, a gear ratio of the drive-force transmitting apparatus 16 becomes dependent of the gear ratio EL of the gear mechanism 28. Further, when the second drive-force transmitting path PT2 provided with the continuously variable transmission 24 is established, the gear ratio of the drive-force transmitting apparatus 16 can be continuously changed by operation of the continuously variable transmission 24. Further, the first clutch C1 is provided to connect and disconnect the carrier 26c and the sun gear 26s of the planetary gear device 26p that constitutes the forward/reverse switching device 26, to and from each other, such that all rotary elements of the planetary gear device 26p are to be rotated integrally with one another with the first clutch C1 being engaged. Therefore, the drive force of the engine 12 is transmitted toward the gear mechanism 28 through the forward/reverse switching device 26, so that it is possible to cause the vehicle 10 to run in the forward direction with the drive force being transmitted to the drive wheels 14 along the first drive-force transmitting path PT1.

While the preferred embodiment of this invention has been described in detail by reference to the drawings, it is to be understood that the invention may be otherwise embodied.

For example, in the above-describe embodiment, the lock-up clutch LU is constructed such that the operating state of the lock-up clutch LU is adjusted by adjusting a hydraulic pressure supplied to the engaging-side fluid chamber 45a and a hydraulic pressure supplied to the releasing-side fluid chamber 45b. However, in the present invention, the construction of the lock-up clutch LU is not necessarily limited to these details. For example, the lock-up clutch LU may be constituted by a multi-plate friction engagement device. In this case, too, as well as in the above-described embodiment, a hydraulic pressure, which is to be supplied to a hydraulic chamber of the friction engagement device, is supplied to the hydraulic chamber through the control valve LUCV. For example, the control valve LUCV may be constructed such that the hydraulic chamber of the friction engagement device is connected to the drain port through the control valve LUCV when the control valve LUCV is placed in the lock-up-off establishing state (i.e., second communicating state), and such that a hydraulic pressure regulated by the lock-up control solenoid valve SLU is supplied to the hydraulic chamber of the friction engagement device through the control valve LUCV when the control valve LUCV is placed in the lock-up-on establishing state (i.e., first communicating state).

In the above-described embodiment, when the control valve LUCV is placed in the lock-up-on establishing state, the lock-up pressure Plu to which a hydraulic pressure is regulated in the control valve LUCV is supplied to the engaging-side fluid chamber 45a. However, the lock-up controlling pressure Pslu outputted from the lock-up control solenoid valve SLU may be supplied to the engaging-side fluid chamber 45a through the control valve LUCV, without the lock-up controlling pressure Pslu being regulated in the control valve LUCV, when the control valve LUCV is placed in the lock-up-on establishing state.

In the above-described embodiment, the mode switching clutch SOWC is constructed such that the first struts 72a and the torsion coil springs 73a are interposed between the input-side rotary member 68 and the first output-side rotary member 70a and such that the second struts 72b and the torsion coil springs 73b are interposed between the input-side rotary member 68 and the second output-side rotary member 70b. However, in the present invention, the construction of the mode switching clutch SOWC is not necessarily limited to these details. That is, the invention is applicable to any mode switching clutch whose operating mode is to be switched between at least the one-way mode and the lock mode, such that the mode switching clutch is configured to transmit the drive force during the driving state of the vehicle and to cut off transmission of the drive force during the driven state of the vehicle when the mode switching clutch is placed in the one-way mode, and such that the mode switching clutch is configured to transmit the drive force during the driving state of the vehicle and during the driven state of the vehicle when the mode switching clutch is placed in the lock mode.

In the above-described embodiment, the operating mode of the mode switching clutch SOWC is to be switched between two modes consisting of the one-way mode and the lock mode. However, the mode switching clutch SOWC may be constructed such that the operating mode of the mode switching clutch SOWC is to be switched among three or more modes including, in addition to the one-way mode and the lock mode, for example, a free mode in which transmission of the drive force is cut off irrespective of whether the vehicle is in the driving state or in the driven state.

In the above-described embodiment, the second drive-force transmitting path PT2 is provided with the continuously variable transmission 24 that is a belt-type continuously variable transmission. However, the continuously variable transmission mechanism provided in the second drive-force transmitting path PT2 may be a toroidal-type continuously variable transmission, for example. Further, the second drive-force transmitting path PT2 may be provided with a step-variable transmission in place of the continuously variable transmission.

In the above-described embodiment, the modulator pressure Pm to which a hydraulic pressure is regulated by the modulator valve (not shown in the drawings) is supplied to the second input port 106 of the control valve LUCV. However, in place of the modulator pressure Pm, another hydraulic pressure such as (i) a line pressure PL to which a hydraulic pressure is regulated by a regular valve and (ii) a secondary pressure PL2 to which the line pressure PL is regulated by a second regulator valve, may be supplied to the second input port 106.

It is to be understood that the embodiment described above is given for illustrative purpose only, and that the present invention may be embodied with various modifications and improvements which may occur to those skilled in the art.

### NOMENCLATURE OF ELEMENTS

12: engine
14: drive wheels
16: vehicle drive-force transmitting apparatus
20: torque converter
24: continuously variable transmission
28: gear mechanism
98: first fluid passage (fluid passage)
C1: first clutch
C2: second clutch
SOWC: mode switching clutch
LU: lock-up clutch
LUCV: lock-up clutch control valve
SR: switching solenoid valve
PT1: first drive-force transmitting path
PT2: second drive-force transmitting path

What is claimed is:

1. A drive-force transmitting apparatus to be installed in a vehicle that includes an engine and drive wheels,
the drive-force transmitting apparatus comprising a first clutch, a second clutch, a mode switching clutch and a torque converter that includes a lock-up clutch, the drive-force transmitting apparatus defining first and second drive-force transmitting paths that are provided in parallel to each other between the engine and the drive wheels,
wherein the first drive-force transmitting path is provided with the first clutch and the mode switching clutch, such that the first clutch is disposed between the mode switching clutch and the engine in the first drive-force transmitting path,
wherein the second drive-force transmitting path is provided with the second clutch,
wherein the torque converter is provided between the engine and the first and second drive-force transmitting paths, and
wherein an operating mode of the mode switching clutch is to be switched between at least a one-way mode and a lock mode, such that the mode switching clutch is configured to transmit a drive force during a driving state of the vehicle and to cut off transmission of the drive force during a driven state of the vehicle when the mode switching clutch is placed in the one-way mode, and such that the mode switching clutch is configured to transmit the drive force during the driving state of the vehicle and during the driven state of the vehicle when the mode switching clutch is placed in the lock mode,
the drive-force transmitting apparatus further comprising:
a switching solenoid valve configured to output a switching pressure by which the operating mode of the mode switching clutch is to be switched between at least the one-way mode and the lock mode; and
a lock-up clutch control valve configured to switch an operating state of the lock-up clutch between an engaged state and a released state;
wherein the mode switching clutch is placed in the lock mode when the switching pressure is supplied from the switching solenoid valve to the mode switching clutch, and
wherein the lock-up clutch control valve is configured to receive the switching pressure supplied from the switching solenoid valve, and to switch the operating state of the lock-up clutch to the released state when the switching pressure is supplied from the switching solenoid valve to the lock-up clutch control valve.

2. The drive-force transmitting apparatus according to claim 1, further comprising a gear mechanism and a continuously variable transmission,
wherein the gear mechanism is provided in the first drive-force transmitting path, and is disposed between the mode switching clutch and the engine in the first drive-force transmitting path, and
wherein the continuously variable transmission is provided in the second drive-force transmitting path.

3. The drive-force transmitting apparatus according to claim 2, further comprising a forward/reverse switching device which is provided in the first drive-force transmitting path and which is disposed between the gear mechanism and the engine in the first drive-force transmitting path,
wherein the forward/reverse switching device is constituted by a planetary gear device, and
wherein the first clutch is configured to connect two rotary elements of the planetary gear device to each other and to disconnect the two rotary elements from each other.

4. The drive-force transmitting apparatus according to claim 1,
wherein each of the mode switching clutch and the lock-up clutch control valve is connected to the switching solenoid valve through a fluid passage through which the switching pressure outputted by the switching solenoid valve is to be supplied to the mode switching clutch and the lock-up clutch control valve.

5. The drive-force transmitting apparatus according to claim 1,
wherein the lock-up clutch is to be placed in the engaged state when a lock-up pressure is supplied through the lock-up clutch control valve to a fluid chamber defined in the torque converter, and is to be placed in the released state when the lock-up pressure is discharged through the lock-up clutch control valve from the fluid chamber,
wherein the lock-up clutch control valve is to be switched between a first communicating state and a second communicating state, such that the lock-up clutch control valve allows supply of the lock-up pressure through the lock-up clutch control valve to the fluid chamber, when the lock-up clutch control valve is placed in the first communicating state, and such that the lock-up clutch control valve allows discharge of the lock-up pressure through the lock-up clutch control valve from the fluid chamber, when the lock-up clutch control valve is placed in the second communicating state, and
wherein, when the switching pressure is supplied from the switching solenoid valve to the lock-up clutch control valve, the lock-up clutch control valve is placed in the second communicating state, whereby the lock-up pressure is discharged through the lock-up clutch control valve from the fluid chamber so as to place the lock-up clutch in the released state.
